(19) United States
(12) Patent Application Publication
(10) Pub. No.: US 2013/0117155 A1
(43) Pub. Date: May 9, 2013

(54) Transaction validation by location based services (LBS)

(71) Applicant: Michael Laine Glasgo, Seattle, WA (US)

(72) Inventor: Michael Laine Glasgo, Seattle, WA (US)

(21) Appl. No.: 13/373,103

(22) Filed: Nov. 4, 2011

(51) Int. Cl. G06Q 30/06

(52) U.S. Cl. 705/26.35

(57) ABSTRACT

A commercial transaction is associated with a current location of a wireless device having location services enabled at the time of the transaction. The current location is compared to an entry in a database of associated merchants accepting transactions to the locations that they handle such transactions. If a match in location is found, the transaction may be validated. If the wireless device registered as the device of the person believed to be conducting the transaction is not at an expected or acceptable location at the time of the transaction, then the transaction may be flagged for possible fraudulent activity. At the time of the transaction, a software location based services (LBS) trigger is initiated to request validation of the transaction based on the wireless device's current location.

### BACKGROUND OF THE INVENTION

1. Field of the Invention

This invention relates to validation of commercial transactions using the location of a wireless device. In particular, it relates to the use of a mobile phone for independent verification of a commercial transaction based on proximity of the wireless device to the location of the transaction.

2. Background of Related Art

Marketers are always trying to reach customers in new and innovative ways. To this end, certain technologies are emerging to allow not only targeted marketing and advertising to consumers based on their location, but also to allow wireless phone users to pay for goods and services using their cell phone.

An electronic wallet is typically defined as an encrypted storage medium holding credit card, phone account number, or other financial information that can be used to complete electronic transactions without re-entering the stored data at the time of the transaction. Other electronic wallets are applications that run on a personal computer to enable a consumer to securely and conveniently access information, make payments, receive and manage bills, bank, and conduct other forms of commerce.

In general, a wireless phone electronic wallet application allows a user to make a payment electronically rather than using cash, taking yet another step toward a cashless society.

Unfortunately, along with technological advances and convenience comes additional opportunities for fraud. To provide a layer of security to electronic wallet applications, communications are typically performed via secure channels.

Nevertheless, fraud opportunities exist for the persistent.

Financial institutions and merchants currently rely on manual visual verification of identification (ID) of a person via a photo ID, most often a state driver's license, etc. A method is also in use at remote transactions stations, such as gas pumps, where the user is prompted to enter information such as home zip code via a remote terminal.

Unfortunately, merchants often do not verify, or improperly verify, or verify based on a forged photo ID such as a driver's license. Identity cards can be falsified or stolen along with the credit card being used to make the transaction, making unauthorized transactions even more possible. Also, current technology that prompts a user for information such as zip code of the billing address for a given credit or debit card can be an unreliable method of verification, especially when transactions are occurring in the home zip code of most of the customers for that transaction site.

Financial institutions seek means to verify identity of individuals conducting financial transactions, such as credit card, debit card, or electronic wallets. This can include asking to see picture ID, but in the case of unattended purchase points, such as gas station pumps, may include prompting the individual to enter information such as home zip code, etc.

### SUMMARY OF THE INVENTION

In accordance with the principles of the present invention, a method of validating a commercial transaction comprises receiving a request to validate a given transaction between the registered possessor of a wireless device and a merchant. A current position of the wireless device is obtained. The current position of the wireless device is compared to an expected location or region relating to the merchant. A validation response to the request is returned, the validation response relates to validation of the given transaction, if the comparison results in an appropriate match.

A method of obtaining location-based validation of a given commercial transaction in accordance with another aspect of the invention, comprises establishing a session with a wireless customer relating to a commercial transaction. A location-based validation of the commercial transaction is requested based on a current location of the wireless customer. The location-based validation of the commercial transaction is received, and the commercial transaction is accepted and completed based on the receipt of the location-based validation.

### BRIEF DESCRIPTION OF THE DRAWINGS

Features and advantages of the present invention will become apparent to those skilled in the art from the following description with reference to the drawings, in which:

FIG. 1 depicts device based triggering of a location push event, triggering transmission of proximate points of interest within a range of the device, to the device, in accordance with the principles of the present invention.

FIG. 2 shows in a first embodiment a grid of gross location areas, some (or all) of which contain one or more points of interest, in accordance with the principles of the present invention.

FIG. 3 shows in a first embodiment, detail of an exemplary gross location area, or range, shown in FIG. 2, with proximate areas surrounding each point of interest sized based upon a current relatively slow motion speed (e.g., walking) of the relevant device, in accordance with the principles of the present invention.

FIG. 4 shows in detail an exemplary gross location area, or range, shown in FIG. 2, with proximate areas surrounding each point of interest sized based upon a current relatively fast motion speed (e.g., driving) of the relevant device, in accordance with the principles of the present invention.

FIGS. 5A to 5H show in another embodiment, detail of gross location areas determined based on a current location of the device, and relative speed of the device (e.g., driving speed), in accordance with the principles of the present invention.

FIG. 6 shows a state diagram of the device based triggered push location event, in accordance with the principles of the present invention.

FIG. 7 shows a flow chart of exemplary device based triggered push location event, in accordance with the principles of the present invention.

FIG. 8 depicts a device-based trigger from a wireless phone attempting to perform a given electronic wallet transaction, and subsequent validation of that transaction based on a match of location between the wireless phone and a merchant, in accordance with the principles of the present invention.

FIG. 9 shows exemplary message flow between network elements used for location based validation of a commercial transaction conducted with a wireless phone used as an electronic wallet, in accordance with the principles of the present invention.

FIG. 10 depicts a transaction conducted with a credit card, or other purchase device, attempting to perform a commercial transaction, and subsequent validation of the transaction based on a match of location between the wireless phone of the registered user of the purchase device and a merchant, in accordance with the principles of the present invention.

FIG. 11 shows exemplary message flow between network elements used for location based validation of a commercial transaction conducted with a credit card or other purchase device, in accordance with the principles of the present invention.

### DETAILED DESCRIPTION OF ILLUSTRATIVE EMBODIMENTS

The inventor has appreciated that financial institutions have limited methods to verify the identity of a buyer during commercial transactions. It has been realized that this is particularly a problem when financial transactions occur at non-supervised transaction locations, such as at automotive gas pumps. It has also been realized that it is often the case that merchants do not bother to manually check ID when processing transactions. The inventor hereof has appreciated that an alternate method would be desired that does not rely on human action.

Other institutions, such as merchants selling alcohol, also seek methods to verify identity where it might be useful to verify that identity (and age) by a method other than a picture ID, particularly since it is appreciated that a picture ID could be falsified.

In accordance with the principles of the present invention, the location of a registered wireless device is obtained and compared to the location of a transaction in progress as an independent means of verifying identity.

A commercial transaction is associated with a current location of a wireless device at the time of the transaction. The current location is compared to an entry in a database of associated merchants accepting transactions to the locations that they handle such transactions. If a match in location is found, the transaction may be validated. If the wireless phone of the authorized user of the instrument used in conducting the transaction is not at an expected or acceptable location at the time of the transaction, then the transaction may be flagged for possible fraudulent activity.

The invention is best implemented with a network that accepts a location based service (LBS) request triggered by an event at the transaction location. This request can either be triggered by an application running on the mobile device (device triggered) or by an application running on the network (network triggered).

There are multiple methods for determining precise location (e.g., assisted GPS (AGPS), Time Difference of Arrival (TDOA), etc.), some of which are network centric and some of which are device centric. The recent trend in wireless devices has been driving more and more processing power into the device. This trend has been driven by a combination of Moore's Law and the desire to continue to offer more sophisticated applications to the wireless end user. The inventor herein has appreciated that the end result will be that the device is more active and in some cases the primary engine to calculate its own precise location; it is more likely to be the source or retainer of this location information; and it is more capable of using this locally maintained location information.

Location triggered information is provided, e.g., location specific advertising, blog, video, multimedia content, web page, automatically dialed phone call, pop-up, or other relevant location-based content using a triggered push when the handset itself determines that it has reached the vicinity of a previously downloaded point of interest. The pre-fetching and queuing of points of interest location information based on general location reduces the traffic on the network associated with repeatedly communicating location for comparison to network hosted location points. Increased processing capacity of a wireless device is leveraged, coupled with the increasing role of wireless devices in determining its precise location to facilitate local, autonomous triggering of location specific events at the device.

As a device traverses a wireless network, its active connection is “handed off” between radio network communications endpoints. These endpoints can be towers for PCS, satellites for LEOs or paging networks, wireless routers for WiFi, or other radio network controller components. Regardless of the network, data is typically maintained either within the network or at the device (typically both) such that the device can be located to deliver calls, messages, data, etc. Similarly, the device retains this information such that it can provide this as part of a device endpoint specific transaction. For means of simplicity, the radio connection endpoint will be generically referred to as the “gross location”. An example of this “gross location” is a cell site and sector combination for a terrestrial PCS network. An important aspect is that the device knows its location and tracks its “gross location”, not just the network. In this manner, the device is capable of having a “kernel” that tracks the gross location to trigger on the change. This enables initiating software implemented solely in the wireless device.

The term location based services (LBS) generally relates to consumer and commercial applications that utilize the knowledge of a wireless device user's geographic position. Location information such as street address can be entered directly by a user, but as referred to herein location based services (LBS) relates to location information that is automatically obtained electronically, e.g., using a global positioning system (GPS) in a user's wireless device such as a cell phone or personal digital assistant (PDA). Of course, other methods of precise and gross location are possible, within the principles of the present invention.

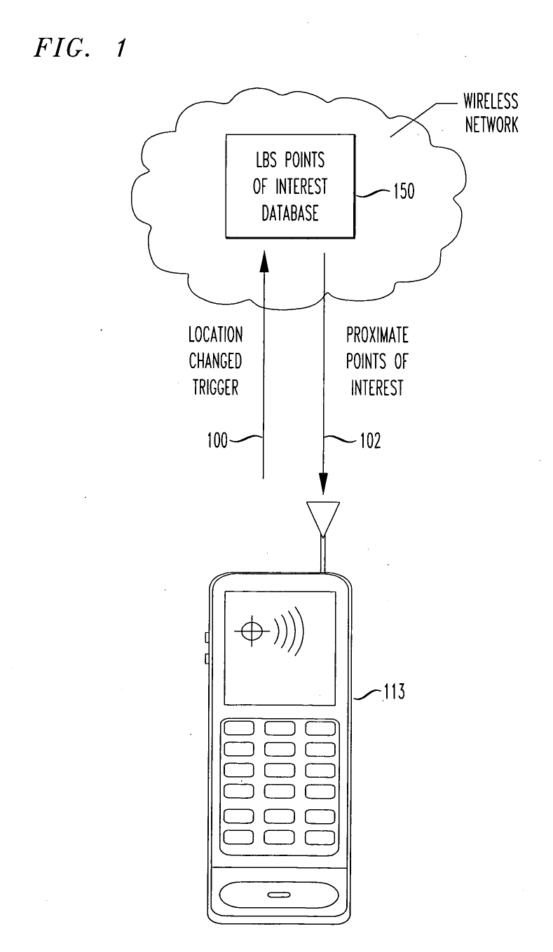

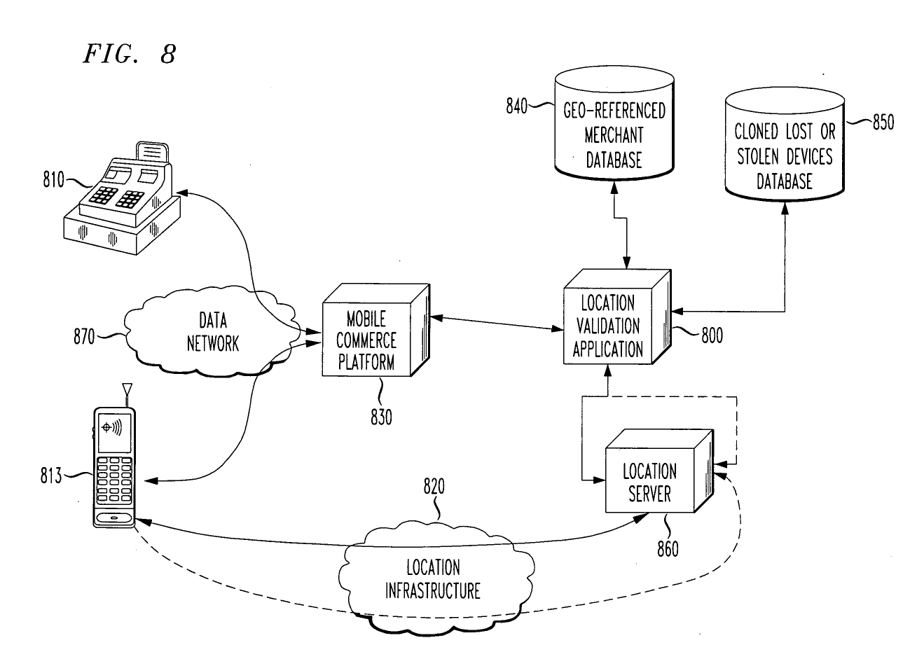

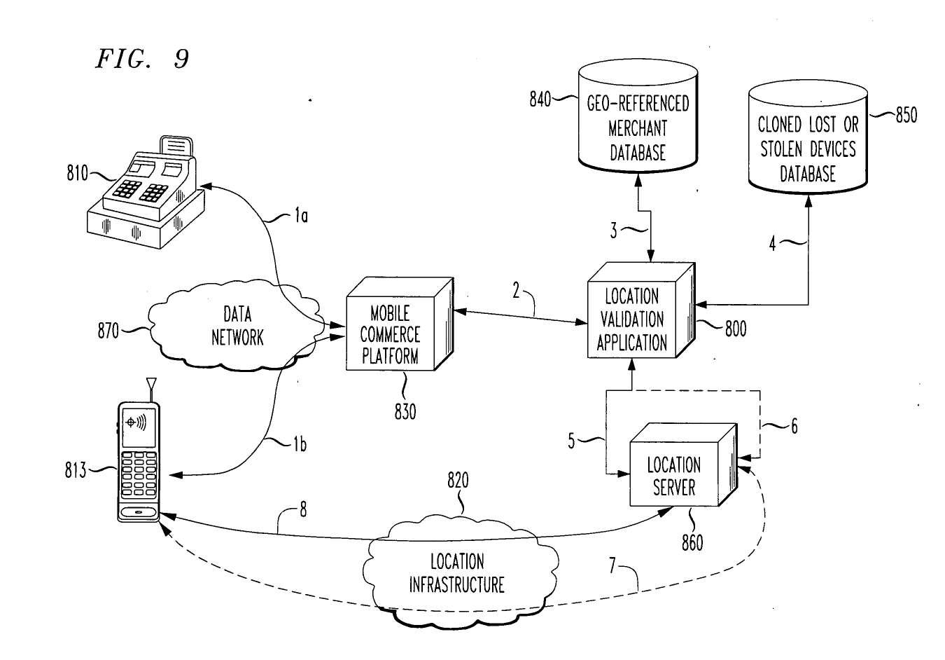

In explaining validation of a wireless device electronic wallet transaction, a device-based triggering of a location update is disclosed first with reference to FIGS. 1-7, followed by explanation of electronic wallet transaction validation as one particular use of that device-based triggering of location with reference to FIGS. 8 and 9.

FIG. 1 depicts device based triggering of a location push event, triggering transmission of proximate points of interest within a range of the device, to the device, in accordance with the principles of the present invention.

In particular, as shown in FIG. 1, a wireless device 113 having the ability to be located notes a change in location and generates an LBS trigger 100. The device passes the same to an appropriate location based information database 150. The gross location could also be determined by the network such as a cell site/sector hand off. In response to a triggered event on the handset, requested location information 102 (e.g., proximate points of interest) relating to the location of the handset is extracted from the location information database 150 and downloaded to the wireless device 113.

The disclosed embodiments describe use of a software LBS trigger 100 initiated by a user's wireless device 113 and passed to a network database 150. The trigger 100 may take one of two forms. The trigger 100 may request the network database 150 to provide the triggering wireless device 113 with a revised set of proximate location information points within a given region or radius R surrounding the user's wireless device 113 current location, based on the user's current location. As the user moves about, from time to time the user will download a revised set of locations of points of interest to provide a sufficient buffer around the handset's current position such that the device can move about and push triggers autonomously for a significant period of time. Alternatively, the trigger 100 may request location based information (e.g., a blog, text, pop-up, video, etc.) relating to the handset having reached a vicinity of a location information point of interest previously downloaded.

The radius R may be defined as a “bubble” or radius (or diameter in a 3D implementation) R centered on the device. The radius R is preferably changed proportionally to the velocity at which the device is moving. The faster the device is moving, the larger the radius R is. This includes more potential matches ahead of time and allows the user to react. In this way, if the user is moving slowly about (e.g., as if shopping within a mall), the radius R of the bubble is preferably defined smaller so that the user does not get spammed with alerts.

Yet another variant is also anticipated wherein the trigger requests a specific application to launch. This can be local to the device, or launched within the network downloaded.

The location information points comprise information relevant to a particular location. They may comprise only a lat/lon of the location, and specific direction as to what to request in a location push upon reaching a vicinity of the lat/lon of the location information point. The location information point may include additional information previously downloaded to the handset, e.g., text message, video, etc. The additional information may be downloaded to the handset over time, in the background of other operations on the handset, to appear to the user to operate more smoothly.

Thus, the location information points can be abstracted to represent only the XY (latitude/longitude) of the point of interest (POI). The key is to let the handset know when it has reached a triggering location.

Location information points may be points of interest, location tagged blogs, commercial locations with advertising focused on the surrounding area serviced by that commercial location, video, multimedia, audio, a phone number to automatically dial, a web page to automatically access, a pop-up to automatically present to the user, an application to launch, etc.

The LBS trigger 100 is initiated at appropriate times by the user's wireless device 113 in response to its detection of significant movement of the user, e.g., the mover is walking, driving, etc. as detected by a locating device (e.g., GPS). The LBS trigger 100 may of course be initiated at additional other times by the user's wireless device 113, e.g., at the startup of a relevant location based services application on the user's wireless device 113, etc.

The LBS trigger 100 to request a revised set of surrounding points of interest is occasionally transmitted as necessary, but preferably is transmitted only when the ‘gross location’ changes. The ‘gross location’ represents a geographic region that could be network topology driven such as a cell site and sector. If it does not change, no triggered event has occurred.

Sufficient location based information is returned by the network database 150 to the triggering wireless device 113, such that the triggering wireless device 113 will receive and buffer location based lat/lon information (and potentially content to be presented to the user upon reaching a vicinity of that lat/lon) relating to areas that the wireless device 113 is not yet proximate to, but which the wireless device 113 may become proximate to, e.g., all of those triggered locations within the region defined as the ‘gross location’. The idea is to provide the wireless device 113 with the anticipated location based information that it immediately needs based on proximity, both to reduce network traffic over time, as well as to provide the user with a smoother, faster operating user interface.

The location based information may be maintained and presented in pre-defined fixed grids, or it may be determined to be proximate to a user's current location on a trigger-by-trigger basis.

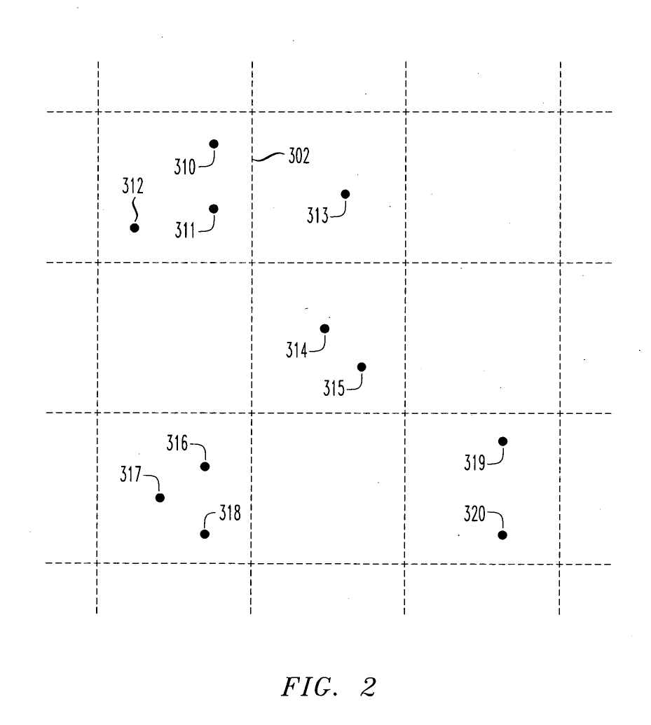

With respect to the use of pre-defined fixed grids, FIG. 2 shows in a first embodiment a grid of gross location areas, or ranges, some (or all) of which contain one or more points of interest, in accordance with the principles of the present invention.

In particular, as shown in FIG. 2, a given geographical area is shown graphically broken into a grid of gross location areas, or ranges. FIG. 2 is shown graphically for ease of description: the location based information may be maintained in an appropriate database in any suitable form, e.g., textual, as latitude/longitude with textual information, textual and photographic, videographic, etc.

A first range 302 shown in FIG. 2 includes three location relevant information points 310-312. For explanation, a number of ranges are shown, some of which include no information points, and others of which contain various numbers of additional information points 313-320.

The information points 310-320 each may contain location based information in any suitable electronic media form (e.g., text, photo, video, audio, short message, email, etc.), but importantly ties that information to a respective given location 310-312. The information point can be a trigger for initiating a different application on the device or in the network, as well as information such as text, photo, email, etc.

The given locations 310-312 may be an exact latitude/longitudinal point, a range of latitude/longitudinal values, or even a vectored range or geometric shape (e.g., a perimeter of a building).

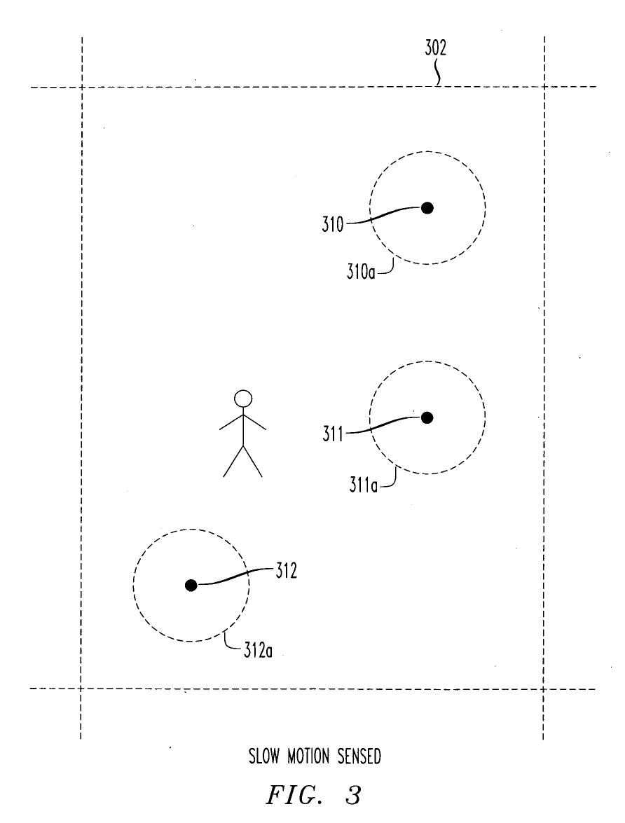

FIG. 3 shows in a first embodiment, detail of an exemplary gross location area, or range, shown in FIG. 2, with proximate areas surrounding each point of interest sized based upon a current relatively slow motion speed (e.g., walking) of the relevant device, in accordance with the principles of the present invention.

In particular, as shown in FIG. 3, the exemplary range 302 of location based information points 310-312 are shown graphically with respective proximate distances 310a-312a depicted around each location based information point 310-312. The proximate distances 310a-312a may be fixed by the network, configurable by the user or network, specific to the needs of an application (such as a walking tour guide application versus a friend finder. The tour guide wants you at a specific point while friend finder might be within a specific range.), or determined based on additional information relating to the user (e.g., their speed).

In particular, the LBS trigger 100 from the triggering wireless device 113 may include additional information relating to the user's wireless device 113 and/or location. For example, the LBS trigger 100 may include information relating to a current or recent speed of the user (e.g., a current speed, average speed, median speed, range of speed, etc.) Speed of the user information may be used to define a suitable range around the user's current location for which the triggering wireless device 113 will be presented with relevant location information. The size of the range 302 for which location information points is provided is preferably based on network topology (to minimize traffic overhead), but may also make use of additional information, as well as any relevant physical equipment limitations such as the available amount of memory in the triggering wireless device 113, network bandwidth limitations, etc.

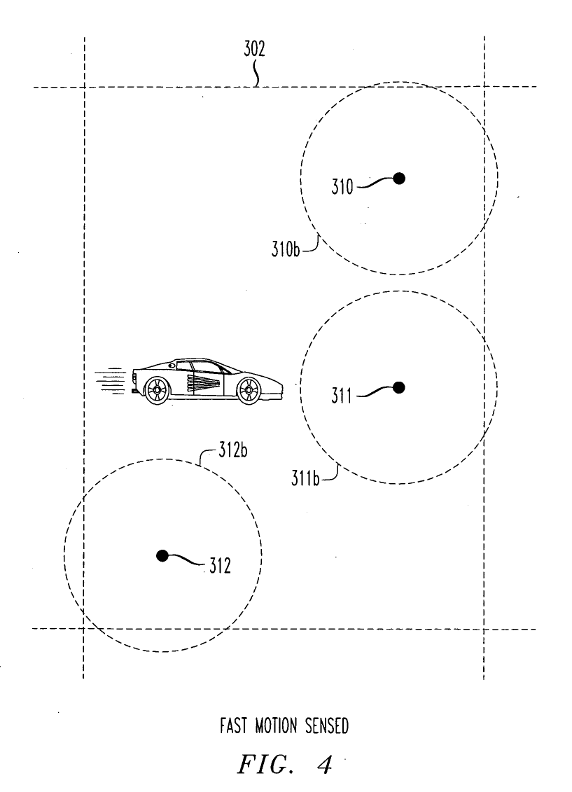

If the user is moving slowly (e.g., walking) as depicted in FIG. 3, a smaller proximate area 310a-312a may be defined, with relevant location-based information points (e.g., triggers for either presenting previously downloaded content relating to points of interest, location tagged blogs, video, audio, pop-up, etc.) within that smaller proximate area 310a-312a being provided so that the device application can autonomously present the same to the user at an appropriate time in the future if/when the user becomes proximate to a location point 310-312 for which location information was previously obtained. On the other hand, if the user is moving fast (e.g., driving), a larger area of proximity 310b-312b may be defined (FIG. 4), as compared to a smaller area of proximity 310a-312a (FIG. 3) defined for a slow moving user (e.g., walking), providing the user with the location information for locations that are comparatively farther from the user's current location. In particular, FIG. 4 shows in detail an exemplary gross location area, or range, shown in FIG. 2, with proximate areas surrounding each point of interest sized based upon a current relatively fast motion speed (e.g., driving) of the relevant device 113, in accordance with the principles of the present invention.

While FIGS. 3 and 4 depict modification of a range of location information point triggers based on velocity and/or direction, other information may be additionally or alternatively considered. For instance, network topology of the area surrounding the user's current location may additionally or alternatively be considered. If the network is considered to be a series of overlapping cells with points of interest in each of the cells, then as a person/device traverses the cells, a handoff occurs as normal network operation. This handoff provides gross location based on network topology. Thus, speed is essential to consider since if the user/device is moving at a high rate of speed (e.g., in a car, high speed train, airplane, etc.), it may likely necessitate the delivery of location point of interest data for multiple network cells so that the handset will have previously downloaded location information point triggers relating to the multiple cells.

Importantly, the embodiments describe storage of the location-based information points 310-312 and associated location based information locally on the user's device subject to network and device limitations, and presentation of the location based information to the user when the user gets closely proximate, i.e., within the proximate area 310a-312a associated with to the respective information point 310-312. Alternatively, the downloaded and locally stored location-based information points 310-312 and associated information may comprise the location point, proximate area 310a-312a, and a reference or semaphore representing a downloaded local or network resident application to trigger based on proximity to the respective information point

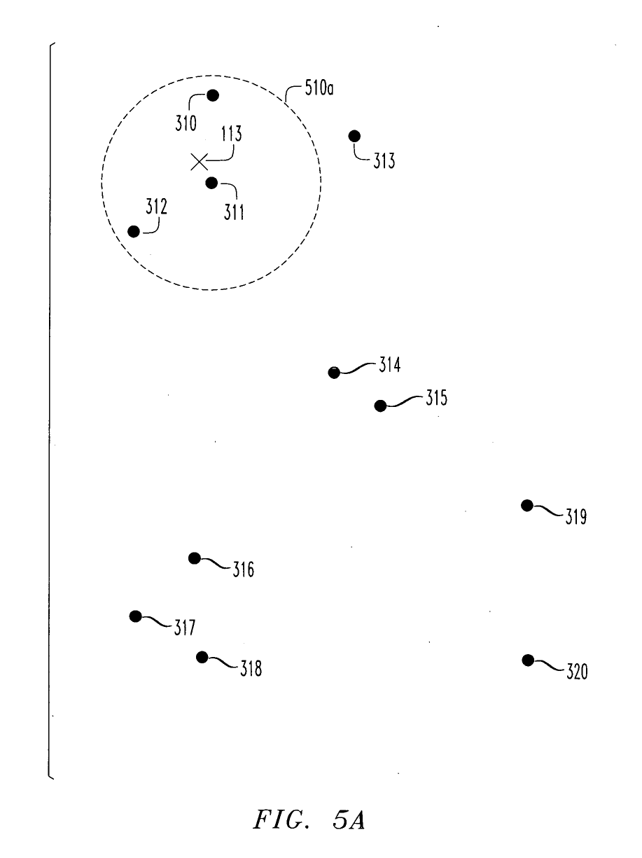

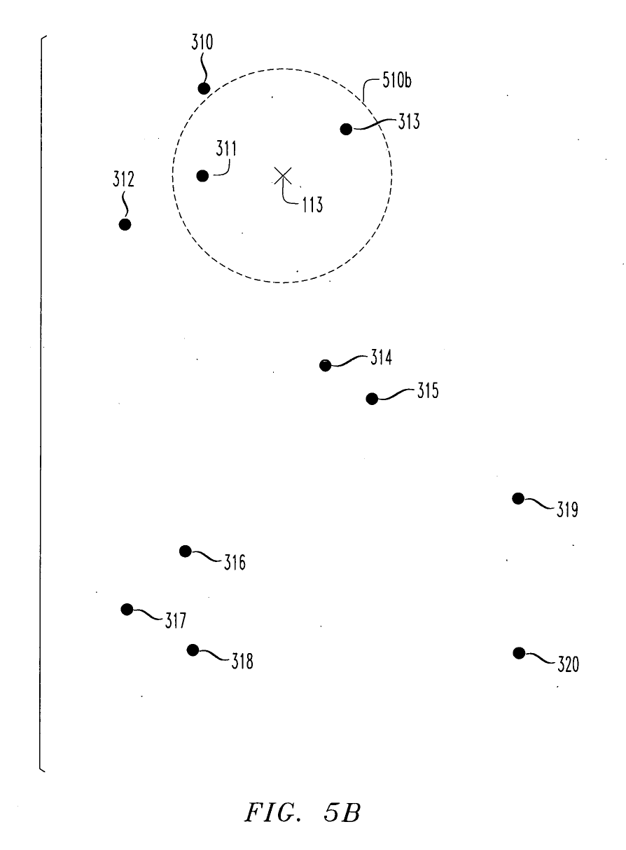

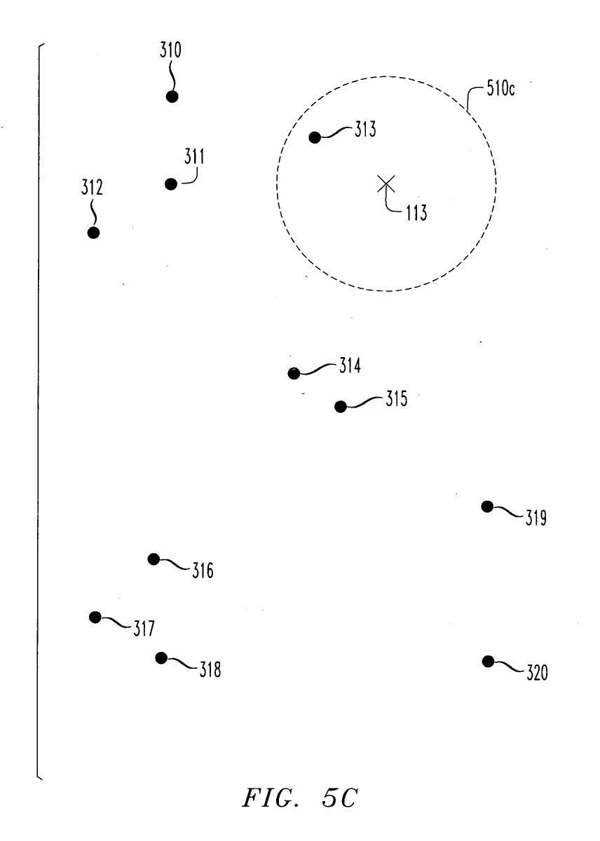

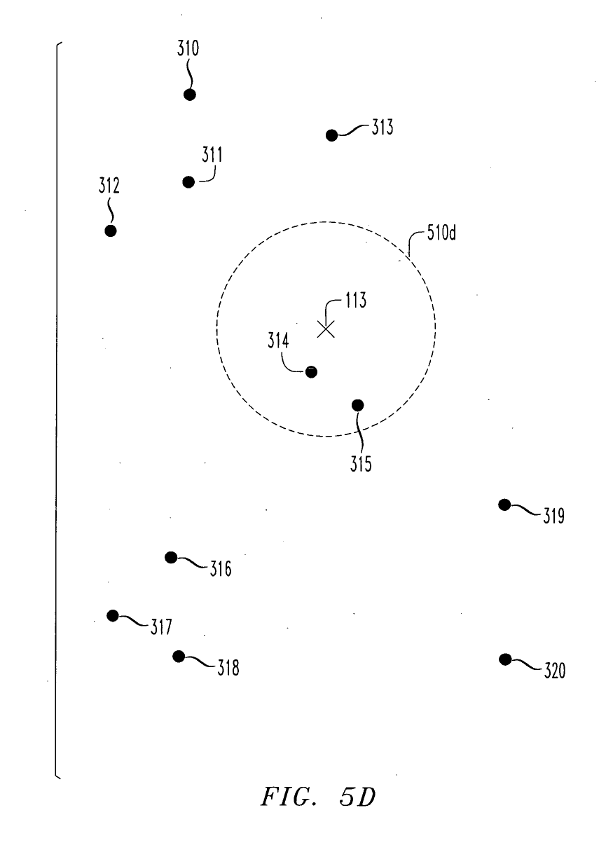

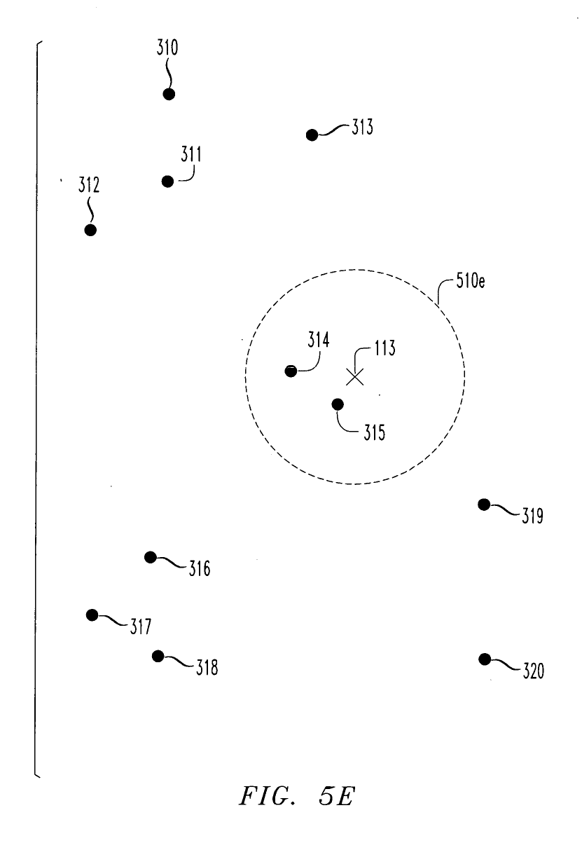

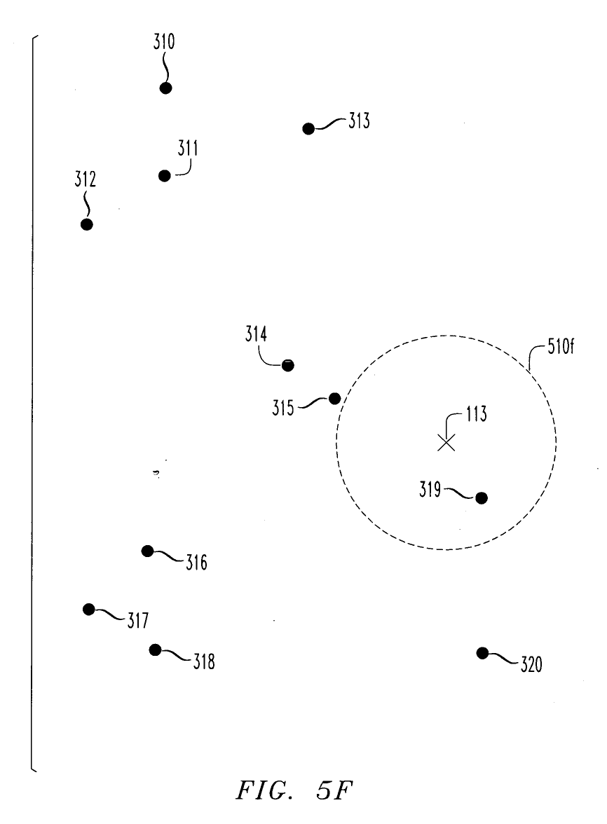

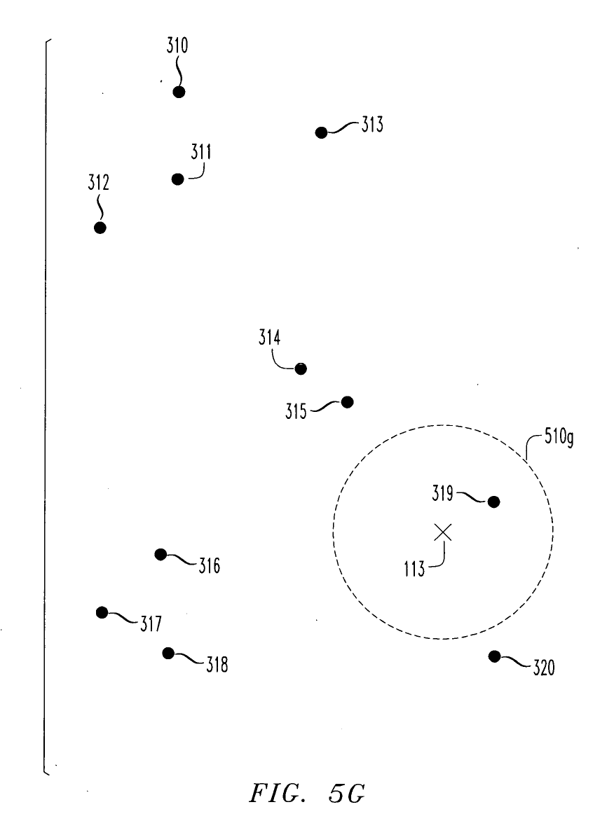

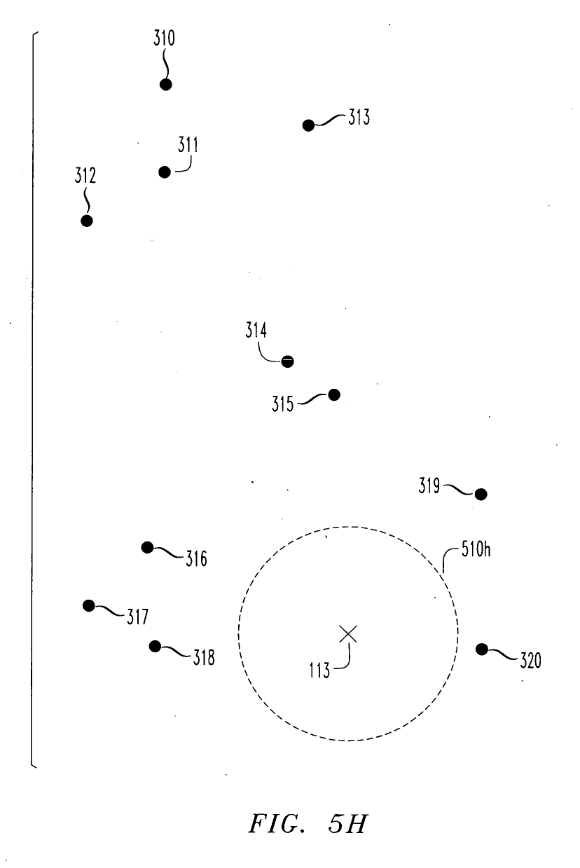

Location based information may alternatively be provided in a custom fashion centered on a user's current location on a trigger-by-trigger basis. For instance, FIGS. 5A to 5H show in another embodiment, detail of a proximate range 510 determined for a given wireless device 113 as it moves about. The size (and shape) of the proximate range 510 may be pre-determined by the service provider or user, configured by the service provider and/or user, and/or adjusted based on current information received from the wireless device 113 (e.g., based on the speed of the wireless device 113).

For ease of description and explanation, the points of interest 310-320 are depicted in the same locations in FIGS. 5A to 5H as they were in the grid of ranges shown in FIG. 2, but without a pre-defined grid. Instead, in this embodiment, the range for which location information points are provided to the user is determined based on a current location of the wireless device 113 at the time that the LBS trigger 100 is sent.

Note that more frequent transmission of the LBS trigger 100 from the wireless device 113 will ensure that the wireless device 113 will not come upon a particular location for which location information is in the location based information database 150 but for which the wireless device 113 had not received location information relating to that location. The size of the proximate range 510 should be sized to allow the wireless device 113 a significant amount of time to move about without having to send another LBS trigger 100 in a way that it won't ordinarily be in a location outside the proximate range 510 at the time of the last download of location based information.

As shown in FIG. 5A, the wireless device 113 generates an LBS trigger 100, and receives location information for any/all location points within the proximate range 510a at that time. At that time, the proximate range 510a includes location points 310-312.

In FIG. 5B, the wireless device 113 again generates an LBS trigger 100 after having moved from its location shown in FIG. 5A. At this time, the wireless device 113 receives location information relating to location points 310, 311 and 313 contained within the proximate range 510b at the time that the LBS trigger 100 was generated.

In FIG. 5C, the wireless device 113 has again moved, again generated an LBS trigger 100, and this time received location information relating to location point 313 located within the proximate range 510c.

In FIG. 5D, the proximate range 510d defined at the time that yet another LBS trigger 100 is generated, includes location points 314 and 315.

In FIG. 5E, the wireless device 113 has moved south, has generated another LBS trigger 100, causing the definition of a proximate range 510e including information points 314 and 315.

In FIG. 5F, a proximate range 510f is defined in response to another LBS trigger 100, the proximate range 510f including location point 319 only.

In FIG. 5G, the new proximate range 510g includes location point 319 only (again).

In FIG. 5H, the wireless device 113 has generated an LBS trigger 100, defining a proximate range 510h, but this time there are no location points in the database with latitude/longitude location points located within this proximate range 510h.

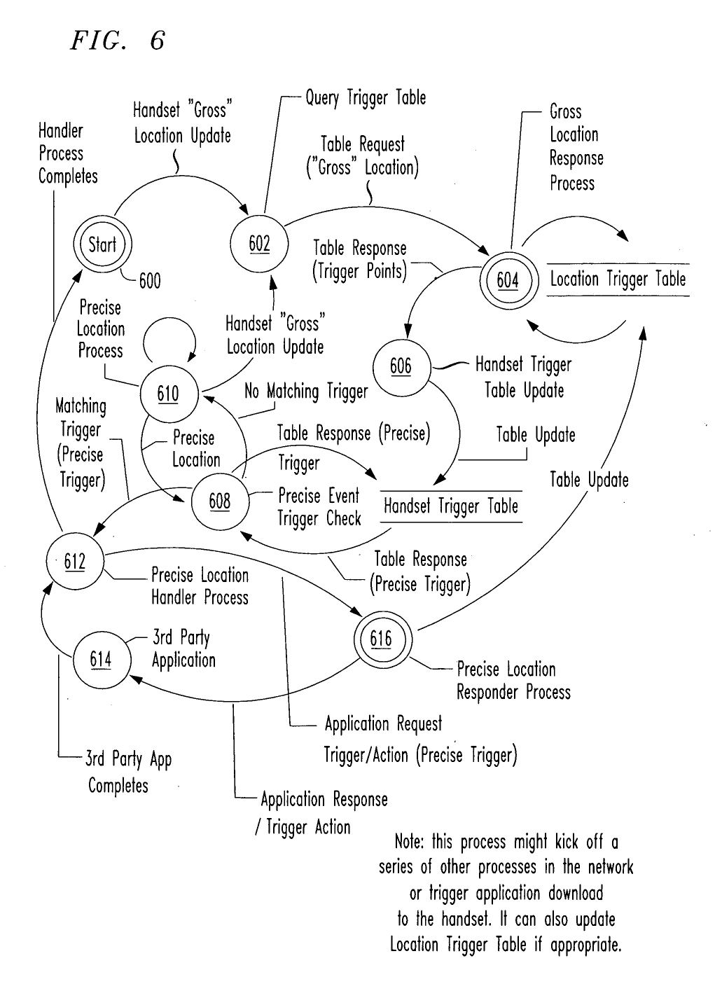

FIG. 6 shows a state diagram of the device based triggered push location event, in accordance with the principles of the present invention.

In particular, as shown in FIG. 6, in accordance with the invention, as shown by state 600, an application (e.g., a small application) is activated on the device that sends an LBS trigger 100 that requests download of “point of interest” trigger points based on changes in the current location, or “gross location”, of the wireless device 113.

The request preferably not only includes the current location of the wireless device 113, since this is maintained by the device 113, but it also preferably includes a unique identifier of the device 113. The format of this tuple may be defined in any appropriate manner.

The device provided information is used to pre-fetch a table of location information points based on a device/user specified profile. As described, the table of location information points includes only those precise location information points X/Y coordinates within a proximity of the current location of the wireless device 113.

As the wireless device 113 traverses the network, the device 113 updates (tracks) precise location at the device level but does not need to communicate this data to the network. (This can be said to infer that assistance data has been downloaded, that precise location is enabled, etc.) The LBS application compares the current location X/Y of the wireless device 113 to currently held location information points (e.g., 310-312) to determine if/when to trigger an event at the wireless device 113 based on a proximity calculation between the current location X/Y of the wireless device 113 and the relevant location information point X/Y 310-312. In this embodiment, a match between the current location of the wireless device 113 and a stored location information point 310-312 results in a request to the serving network with a request to download relevant location information for that location. In this way, a specific trigger for download of location relevant information occurs only when a wireless device 113 first reaches a proximity of a given location information point. The appropriate trigger action is then taken, whether it is to download a location specific application, advertisement, coupon, game trigger event, blog, etc. to the handset. In this manner, the desired location specific event has been triggered by the device and executed while minimizing the amount of communications and data required for download to the handset.

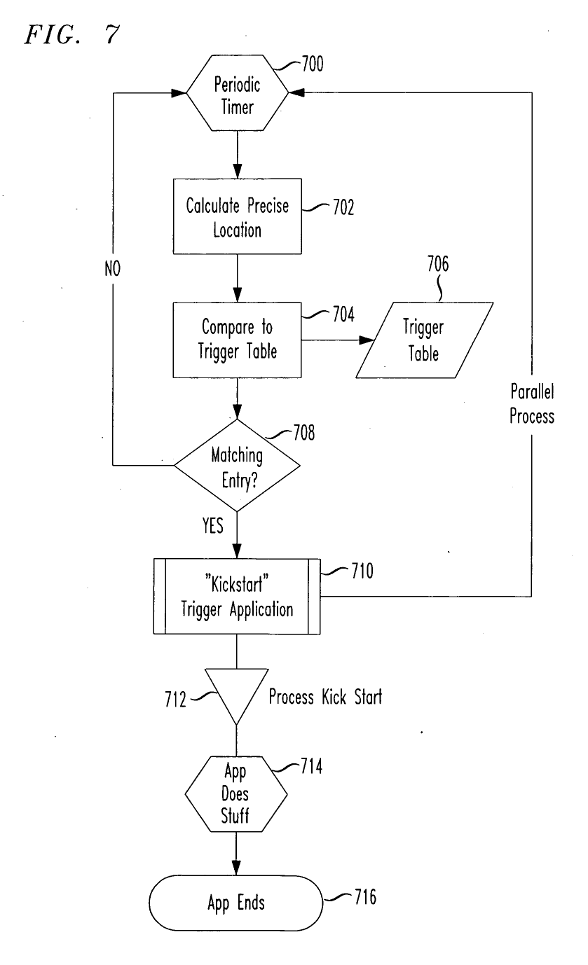

FIG. 7 shows a flow chart of exemplary device based triggered push location event, in accordance with the principles of the present invention.

In particular, LBS triggers 100 may be generated when a significant change in location is detected by the wireless device 113. As shown in step 700 of FIG. 7, a periodic timer in the wireless device 113 occasionally determines if the current location of the wireless device 113 is within a proximate area of any location information points that have been previously downloaded to the wireless device 113. The idea is that the device is recalculating location periodically anyway, so the trigger can be based on time or some other factor such as motion, velocity, direction, or user action.

In step 702, upon expiration of the timer, a current location of the wireless device 113 is determined.

In step 704, the current location of the wireless device 113 is compared to the X/Y longitude/latitude, plus any relevant proximate area surrounding each location information points, of any/all location information points (e.g., 310-312).

In step 706, the current location of the wireless device 113 is compared to a proximate area around each location information point stored in a local trigger table.

In step 708, it is determined if the current location of the wireless device 113 matched a given location information point. If not, the process sits idle until the timer in step 700 again times out.

However, if so, then the process proceeds to step 710, appropriate action is taken to present the associated location information to the user. The trigger could also kick off an entirely new application within the network, e.g., a tracking software application if a person of interest moves outside of a defined perimeter.

For example, specific text, video, or audio information may be requested for download from the location information database 150 at that time to the wireless device 113. This process of obtaining the location information, or kickstarting as shown in step 712, is referred to herein as a kickstart trigger application. This process may be a semaphore, though it need not be.

Note that the timer in step 700 continues to run and check matches with other location points, regardless of whether or not previously location information is being presented to the user (i.e., the location information may overlap).

In step 714, the handset or network application that is waiting for a trigger event to occur (i.e., a match to a location information point) is started, and does its independent processing. This may include location fixes, etc. that are also used for trigger evaluation. It is preferably an independent application that terminates upon completion according to its own rules.

In step 716, the LBS application ends.

The LBS application in the wireless device 113 can take the form of an applet (j2me), a BREW extension, a symbian application, or other coded logic that could be embedded or downloaded and executed on the device. In either case, the LBS application may be made available to other application developers to take advantage of a common XY downloadable table.

The applet table, or list of location information points, can include context when downloaded to the wireless device 113. This is similar to the XY table except that the table instead is a set of “tuples” that define specific characteristics useful to other applications. This information may include privacy settings, user, device info, location, speed, etc. that can be provided as part of the trigger to the network. Alternatively, a match between current location and a previously loaded location information point can be served by the downloaded application on the wireless device 113 if the specific actionable location based information has already been provided as part of a response to the LBS trigger 100.

With respect to the focus of this particular patent application, rather than implement device-based location triggers upon detection of proximity to a predefined trigger point, instead device-based location triggers are utilized to facilitate validation of a commercial transaction. In particular, a transaction is deemed valid if determined to be performed while the wireless device is at a proper location, e.g., within a merchant's retail store. This validation is based on a match between a current location of a wireless device of a subscriber believed to be attempting the transaction, and an expected or acceptable location for that device to be performing that particular transaction (e.g., within an expected retail store, etc.)

Alternatively, and especially for transactions not involving an electronic wallet, the determination of the LBS location of the wireless device can be triggered by an application running on the network.

FIG. 8 depicts a device-based trigger from a wireless phone attempting to perform a given electronic wallet transaction, and subsequent validation of that transaction based on a match of location between the wireless phone and a merchant, in accordance with the principles of the present invention.

A number of companies are pushing the idea of an electronic wallet. With this in mind, FIG. 8 shows an embodiment making use of a device triggered event wherein a location request relating to the wireless phone 813 acting as an electronic wallet confirms whether or not the electronic wallet 813 (and thus its user) is at an expected physical location of a given electronic wallet transaction (e.g., whether the wireless phone 813 is within a merchant's retail store at a time of purchase of goods or services from that merchant 810). While the result in and of itself might not necessarily stop the transaction, if the wireless phone 813 is not conducting an electronic wallet transaction within an expected physical area (e.g., within the merchant's retail store 813), it can be used to note a possible fraud alert for immediate or later follow-up by appropriate personnel.

This embodiment uses location technology to validate payment transactions by locating a mobile phone 813 expected to be at a particular physical location while the possessor is making the payment transaction. FIG. 8 shows network communication between a data network 870, a mobile commerce platform 830, location infrastructure 820, a location server 860, a location validation application 800, and a geo-referenced merchant database 840.

FIG. 9 shows exemplary message flow between network elements used for location based validation of a commercial transaction, including those conducted with a wireless phone used as an electronic wallet, in accordance with the principles of the present invention.

In particular, as shown in FIG. 9, the possessor of a wireless device 813 attempts a commercial transaction, e.g., at a given merchant's retail store 810.

In an effort to validate the transaction, a mobile commerce platform 830 authorizes a location validation application 800 to validate the transaction based on the location of the wireless device 813. To activate the request, the mobile commerce platform 830 passes a proximity validation request 2 to the location validation application 800. The location validation application 800 may be implemented within any suitable server, e.g., within the service provider's network or a third party network.

In the disclosed embodiment, a request to authorize the purchase 1a, 1b may be accepted or denied by either the merchant 810 and/or even by the wireless phone 813.

The location validation application 800 facilitates a comparison between a current location of the wireless device 813 and the merchant 810 using a request 3 to the geo-referenced merchant database 840. The geo-referenced merchant database 840 provides an expected or acceptable location (X, Y), or range of locations (e.g., location and diameter) associated with a given merchant using a unique merchant code in the request.

The geo-referenced merchant database 840 associates a plurality of merchants, each uniquely identified within a unique merchant code, with one or more acceptable transaction locations or regions.

Upon receipt of a request to validate a given transaction, the location validation application 800 passes a request 5 for a current location (X, Y) of the wireless phone 813 to a location server 860. In response, the location server 860 attempts to update its data regarding the location of the requested wireless phone 813 by passing a location request 8 to the wireless phone 813.

The particular location determination method implemented by the location server 860 can be by any suitable technique or methodology, e.g., Cell ID, Enhanced Cell ID, AFLT, Hybrid, WiFi/WiMax Based/Aided, global positioning system (GPS), Assisted GPS (A-GPS), etc.

The wireless phone 813 responds with updated location information as depicted by communication 7. Ultimately, the location server 860 returns the current location of the wireless phone 813 in an answer 6 to the location validation application 800.

Ideally, it is preferred that the current location of the wireless phone returned by the location server 860 be freshly obtained subsequent to the initiation of the transaction, rather than reporting a location of the wireless phone by the location validation application 800 as its last known position. This adds an additional layer of security to the device-based location validation of the electronic wallet transaction.

Thus, validation of a transaction in accordance with the present invention requires the subscriber's proximity to the merchant for the transaction to be deemed valid. Validation is determined based on a match of the current location of the wireless phone attempting the electronic wallet transaction, and a location relating to the merchant, providing an enhanced level of security in the transaction.

For instance, let's say you are buying a product at a store using your mobile device to complete the transaction. In most proposed electronic wallet scenarios, the transaction is communicated between the wireless phone and a merchant terminal via wireless communications, e.g., via infrared, Bluetooth, WiFi, WiMax, etc.

To complete the electronic wallet transaction, the validation request preferably requires at a minimum a unique merchant code. Additional information may relate to the specific transaction being validated, e.g., a product code of goods or service being purchased, the price associated with the transaction, etc.

The transaction validation request 1a is preferably initiated by the merchant 810, but could be initiated by the wireless phone 813.

Accordingly, in accordance with the invention, the location validation application 800 checks whether a transaction by a requesting wireless electronic wallet device 813 is legit, and if so then fires a location request 5 into the network to determine the current location of the wireless electronic device 813. With the current location, a comparison is made to an expected location (or area). A match of the current location of the wireless device 813 to within a proximity to the merchant's location ensures presence of the subscriber at the merchant when conducting the transaction, thus providing an added level of security to an electronic wallet transaction.

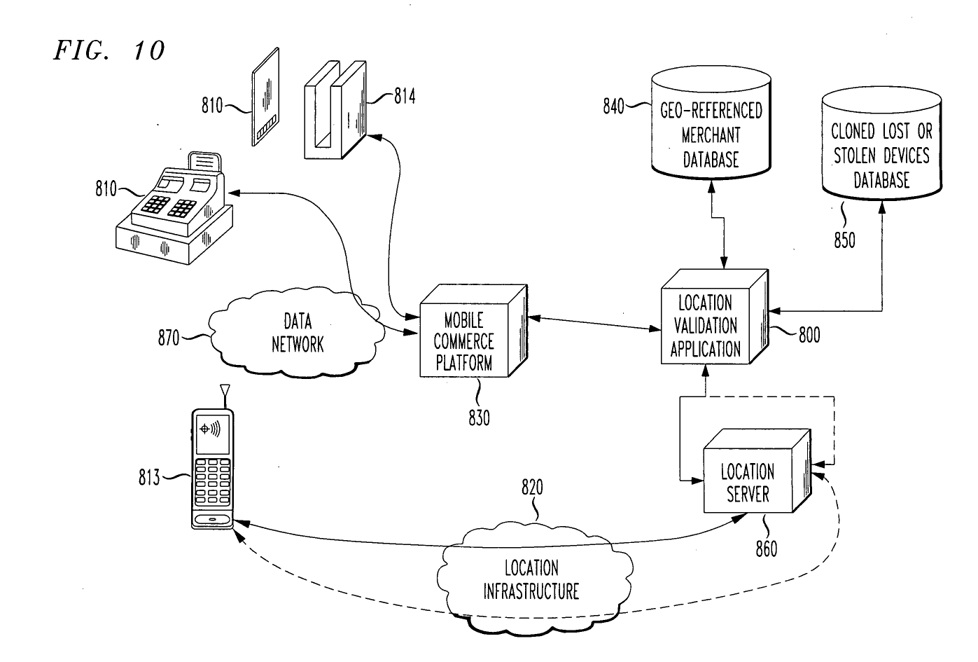

FIG. 10 depicts a transaction conducted without an electronic wallet but with a different purchase mechanism such as a credit or debit card 815 passed thru a reader 814, and subsequent validation of that transaction based on a match of location between a wireless device registered to the authorized user of that different purchase mechanism and the location of the merchant, in accordance with the principles of the present invention.

This embodiment uses location technology to validate payment transactions by locating a mobile phone 813 expected to be at a particular physical location while the expected possessor is making the payment transaction. FIG. 10 shows network communication between a data network 870, a mobile commerce platform 830, a transaction device (credit card) 814, a transaction device reader 815, location infrastructure 820, a location server 860, a location validation application 800, and a geo-referenced merchant database 840.

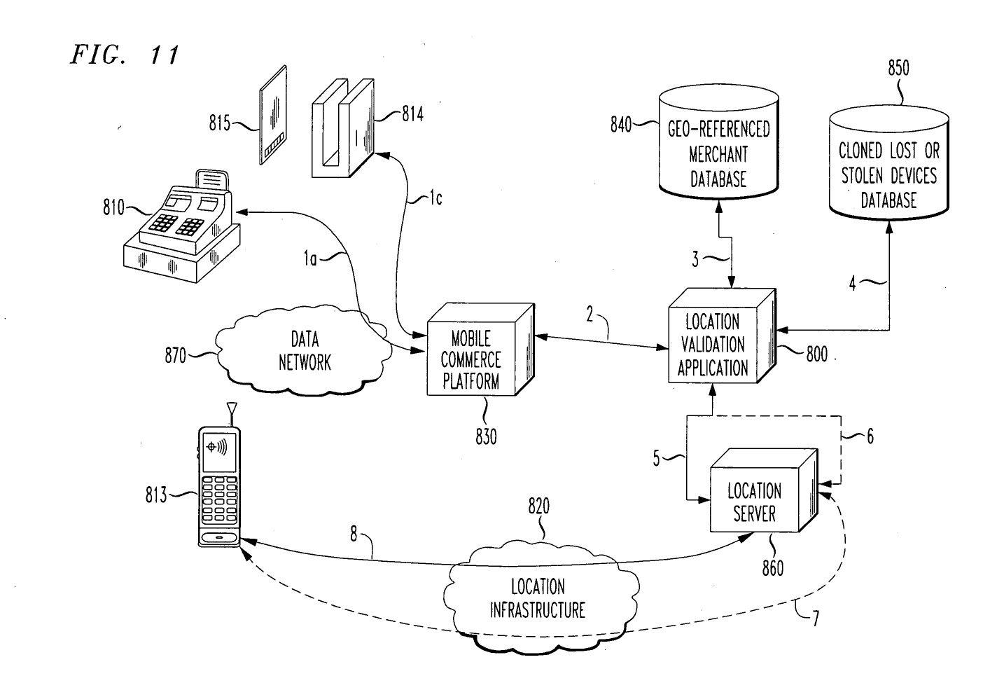

FIG. 11 shows exemplary message flow between network elements used for location based validation of a commercial transaction conducted with a registered device such as a credit card or personal check, in accordance with the principles of the present invention.

In particular, as shown in FIG. 11, a credit card 815 is passed through a card reader 814 to attempt a transaction, e.g., at a given merchant's retail store 810. In the shown example, the transaction is initiated by passing the credit card 815 through the reader 814.

In an effort to validate the transaction initiated by the transaction device 815, a mobile commerce platform 830 authorizes a location validation application 800 to validate the transaction based on the location of the wireless device 813. To activate the request, the mobile commerce platform 830 passes a proximity validation request 2 to the location validation application 800. The location validation application 800 may be implemented within any suitable server, e.g., within the service provider's network or a third party network.

In the disclosed embodiment, a request to authorize the purchase 1a, 1c may be accepted or denied by either the merchant 810 and/or even by the wireless phone 813.

The location validation application 800 facilitates a comparison between a current location of the wireless device 813 and the merchant 810 using a request 3 to the geo-referenced merchant database 840. The geo-referenced merchant database 840 provides an expected or acceptable location (X, Y), or range of locations (e.g., location and diameter) associated with a given merchant using a unique merchant code in the request.

The geo-referenced merchant database 840 associates a plurality of merchants, each uniquely identified within a unique merchant code, with one or more acceptable transaction locations or regions.

Upon receipt of a request to validate a given transaction, the location validation application 800 passes a request 5 for a current location (X, Y) of the wireless phone 813 to a location server 860. In response, the location server 860 attempts to update its data regarding the location of the requested wireless phone 813 by passing a location request 8 to the wireless phone 813.

The particular location determination method implemented by the location server 860 can be by any suitable technique or methodology, e.g., Cell ID, Enhanced Cell ID, AFLT, Hybrid, WiFi/WiMax Based/Aided, global positioning system (GPS), Assisted GPS (A-GPS), etc.

The wireless phone 813 responds with updated location information as depicted by communication 7. Ultimately, the location server 860 returns the current location of the wireless phone 813 in an answer 6 to the location validation application 800.

Ideally, it is preferred that the current location of the wireless phone returned by the location server 860 be freshly obtained subsequent to the initiation of the transaction, rather than reporting a location of the wireless phone by the location validation application 800 as its last known position. This adds an additional layer of security to the device-based location validation of the transaction.

Thus, validation of a transaction in accordance with the present invention requires the registered owner of the transaction device to be in proximity to the merchant for the transaction to be deemed valid. Validation is determined based on a match of the current location of the wireless phone of the person registered as authorized to use the transaction device, and a location relating to the merchant, providing an enhanced level of security in the transaction.

For instance, let's say you are buying a product at a store using a credit card 815 to complete the transaction. In most proposed scenarios, the transaction is communicated between the card reader 814, the merchant 810, and the mobile commerce platform 830.

The transaction validation request 1a, 1c is initiated by the merchant 810.

Accordingly, in accordance with the invention, the mobile commerce platform 830 checks whether a transaction by a requesting device 815 is legitimate, and if so then makes a request 2 to the location validation application 800 which fires a location request 5 into the network to determine the current location of the wireless electronic device 813. With the current location, a comparison is made to an expected location (or area). A match of the current location of the wireless device 813 to within a proximity to the merchant's location ensures presence of the registered user of the purchase device 815 at the merchant when conducting the transaction, thus providing an added level of security to the transaction.

Additionally, if the location does not match, a message can be sent to the mobile device indicating that someone has used the transaction device 815 at another location and requesting confirmation through a message back from the mobile device indicating permission for that user to make the purchase.

Additionally, transactional tracking may be implemented. For instance, transactions may be tracked with location information included, i.e., a location of the wireless device reported for each transaction that took place. In particular, a transaction log may be maintained to provide detailed archival information relating to transactions, for use in appropriate purposes, e.g., investigation into a later allegation of fraud, etc. The transaction log may maintain information relating particular transactions with a location of the subscriber's wireless phone 813 when used to perform the given transaction. The location information maintained in the transaction log can be retrieved later in case of dispute to prove that the subscriber's device 813 was or wasn't at the merchant's location at the moment that a given transaction was completed.

A match between current location and an expected location of a wireless phone when performing a particular transaction requires a geo-referenced database of merchants 840, a location server 860, and a location validation application module 800 to verify the match. If proximity is determined between the current location of the wireless device 813 and the location of the merchant 810, the transaction can be trusted. Otherwise, if the wireless device 813 is determined to be not proximate to the known location of the merchant 810, the transaction may be flagged for further investigation for trustworthiness, or blocked altogether.

The disclosed embodiments relate to appropriate locations for the merchant being fixed and stored in the geo-referenced merchant database 840. However, the principles of the present invention relate equally to not only a mobile purchaser, but also to a mobile merchant 813. In particular, the current location of a given merchant 813 associated with a merchant code in a given transaction may be determined, along with a current location of the purchaser 813, and compared to determine if the purchaser 813 is appropriately proximate to the merchant 810 at the time of the transaction.

Location validation has additional uses. For instance, as an additional feature, if the wireless device 813 is reported lost or stolen, any future attempted electronic wallet transaction can be blocked. Alternatively, in such a loss or theft case, any future electronic wallet transaction can be allowed to occur invisibly to the presumably unauthorized user of the wireless device 813, but tracked or otherwise monitored by appropriate enforcement or police personnel, providing yet another security enhancement to the user's finances.

Conversely, if electronic wallet transactions were validated, and if the wireless phone 813 used to make the electronic wallet transactions was not reported as lost or stolen, it would be presumed that the subscriber was physically at a given merchant's store because there would be little chance someone else made the purchase. Presumably, if the wireless phone 813 was not there at the time of a given transaction, the transaction shouldn't have been validated (if it was), and thus the subscriber should not be held responsible for the given transaction. In this regard, it is preferable that the mobile commerce platform 830 handling a given electronic wallet transaction should not be validated, and thus should not clear, unless specifically allowed and instructed to do so by the location validation application 800.

In the event that a wireless electronic wallet device 813 is cloned or hacked, and the owner is unaware of it, a location mismatch between current position and expected location of a relevant merchant 810 can be used to trigger notification and preventive/corrective action.

Use of a device-based or network-based triggered Push eliminates the need for polling, and thus greatly minimizes traffic on the network while providing a trigger to other mobile applications. The fraud prevention feature of location validation of a transaction is a response to a specific transactional event. In this application, the wireless device is pinged, or asked for its current location, and establishes a session to determine its location.

As explained above, the triggered device-based Push requires a device resident application to monitor device location and to compare that to a trigger table. If a match is “close enough”, then it triggers an external application (referred to as a “Kickstart”) to complete its work. The fraud prevention embodiment described herein does not require an application to monitor the device's activity, as the location is triggered not by the device reaching a vicinity of a given location but rather by the occurrence of a commerce transaction as part of a verification/fraud avoidance process. Thus, a trigger table and associated logic is not required for the specific application.

While intended for use with location based services (LBS), features of the invention are applicable beyond LBS. For instance, in a non-location based embodiment, a product code may be used to match product description and price for added security, e.g., to ensure a 50″ plasma TV is not sold for $3.00.

Moreover, in applications that utilize LBS, but may not require a triggered Push from the device, a wireless device may be tracked if flagged as being illegally used, or used by a suspect for illegal purposes (e.g., kidnapping, hacking, piracy, etc.) This ability is represented in FIGS. 8 and 9 by the optional inclusion of a cloned, lost or stolen devices database 850, and a message 4 to report/track validation, report/reject validation, and/or not report/accept validation.

If a given wireless phone 813 is being used to conduct illegal activities, law enforcement can instruct the phone's carrier to enable location-based monitoring and tracking on that wireless phone 813. A triggered push application to output a triggered Push passed on to law enforcement personnel may be activated in such an instance. Such tracking may also or additionally be implemented using polling from the network, either mobile device assisted or network based, or by specific location requests for the given wireless device 813 instructing the wireless device 813 to report its current location (i.e., mobile station based embodiment) to a requesting application.

Device-based location validation for transactions is a security enhancement that is attractive for implementations by vendors, and compelling to carriers, financial institutions, and merchants as well as subscribers.

The present invention provides benefits such as fraud detection, missing person location, lost wireless device retrieval, spending pattern analysis, independent photo ID verification, and registered voter verification.

The invention has particular applicability to financial institutions, especially issuers of credit/debit cards, to reduce losses due to fraud. Financial institutions might offer a reduction in fees to the merchant for permitting this additional level of verification.

Non-attended merchant transaction sites, such as gas station pumps, may make particular use of the present invention as an alternative to entry of data via an associated remote terminal/keypad. The invention also has the ability to eliminate the need for a remote terminal/keypad all together, particularly where the keypad might be physically unreliable due to environment conditions, or subject to fraudulent data entry.

Merchants subject to legal constraints regarding age, such as liquor or tobacco product sales, may make use of the present invention to verify a photo ID against registered information (such as age) associated with a wireless device, and the location of that wireless device associated with the legal photo ID.

Mobile phone users may be asked to opt-in to the location-based verification feature of the present invention for their particular wireless device. Moreover, queries may be audited for location of their phone. Unidentified queries may be tracked to use of this invention.

While the invention has been described with reference to the exemplary embodiments thereof, those skilled in the art will be able to make various modifications to the described embodiments of the invention without departing from the true spirit and scope of the invention.

What is claimed is:

1. A method of validating a commercial transaction, comprising:
receiving a request to validate a given transaction between a registered possessor of a wireless device and a merchant;
obtaining a current position of said wireless device that has location services enabled;
comparing said current position of said wireless device to an expected location or region relating to said merchant; and
returning a validation response to said request, said validation response relating to validation of said given transaction, when said comparison results in an appropriate match.

2. The method of validating a commercial transaction according to claim 1, wherein:
said wireless device is a mobile phone.

3. The method of validating a commercial transaction according to claim 1, wherein:
said wireless device is a mobile phone also acting as an electronic wallet.

4. The method of validating a commercial transaction according to claim 1, wherein:
said merchant is mobile.

5. The method of validating a commercial transaction according to claim 2, wherein:
said merchant is mobile.

6. The method of validating a commercial transaction according to claim 1, further comprising:
referencing a geo-referenced merchant database to obtain said expected location or region relating to said merchant.

7. The method of validating a commercial transaction according to claim 1, wherein:
said request to validate said given transaction is initiated by said wireless device.

8. The method of validating a commercial transaction according to claim 1, wherein:
said request to validate said given transaction is initiated by a network-based application.

9. A method of obtaining location-based validation of a given commercial transaction, comprising:
establishing a session with a wireless device relating to a commercial transaction;
requesting location-based validation of said commercial transaction based on a current location of said wireless device, said wireless device having location services enabled;
receiving location-based validation of said commercial transaction; and
accepting and completing said commercial transaction based on said receipt of said location-based validation.

10. The method of obtaining location-based validation of a given commercial transaction according to claim 9, wherein:
said wireless customer is a mobile phone.

11. The method of obtaining location-based validation of a given commercial transaction according to claim 9, further comprising:
providing, along with said request for location-based validation, a current location of a merchant end of said commercial transaction.
